(19) United States
(12) Patent Application Publication
(10) Pub. No.: US 2017/0124073 A1
(43) Pub. Date: May 4, 2017

(54) CODE MIGRATION TOOL USING DISTRIBUTED FILE SYSTEM DIRECTORIES

(71) Applicant: Bank of America Corporation, Charlotte, NC (US)

(72) Inventors: John H. McKenzie, Jacksonville, FL (US); Daniel P. McCoy, St. Augustine, FL (US); Manikumar Juttukonda, Jacksonville, FL (US)

(21) Appl. No.: 14/925,269

(22) Filed: Oct. 28, 2015

(51) Int. Cl. G06F 17/30; H04L 29/08

(52) U.S. Cl. CPC G06F 17/303; H04L 67/1095; G06F 17/30569; G06F 17/30371

(57) ABSTRACT

Aspects disclosed herein are directed to, for example, a system and method of code migration using distributed file system directories. A computing device may send, to a code repository, a request to migrate code. The request may include, for example, an identifier for the code. In response to the request, the computing device may receive, from the code repository, the code. The computing device may generate one or more directories for the code. The computing device may migrate the code to the one or more directories. The code and the one or more directories may be synchronized to one or more other computing devices.

### TECHNICAL FIELD

One or more aspects of the disclosure generally relate to computing devices, computing systems, and computer software. In particular, one or more aspects of the disclosure generally relate to computing devices, computing systems, and computer software that may be used to process, verify and migrate code among computing devices.

### BACKGROUND

Code for computing devices, such as servers and workstations, may occasionally be created or updated by developers. The new code may be migrated (e.g., moved) to the computing devices in order to update the computing devices. There is a need to improve the speed and quality of code migrations in a network of computing devices.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Some aspects as disclosed herein are directed to, for example, a system and method of code migration. The method may comprise sending, by a computing device and to a code repository, a request to migrate code, the request comprising an identifier for the code. In response to the request to migrate, the computing device may receive, from the code repository, the code. The computing device may generate one or more directories for the code. The computing device may migrate the code to the one or more directories. The code and the one or more directories may be synchronized to one or more other computing devices.

The method may comprise generating, for display on a user device, a display screen for a code migration tool of the computing device. In response to receiving, from the display screen, the identifier for the code, the sending the request to migrate the code step may be performed. After migrating the code to the one or more directories, at least one of a read permission, a write permission, and an execute permission may be set for the code. In some aspects, prior to migrating the code to the one or more directories, the code may be converted from a first format to a second format. In these examples, migrating the code to the one or more directories may comprise migrating the code converted from the first format to the second format to the one or more directories.

The one or more directories described herein may comprise a plurality of edge node directories and a plurality of distributed file system directories. Moreover, migrating the code to the one or more directories may comprise copying the code to the plurality of edge node directories and the plurality of distributed file system directories. After migrating the code to the one or more directories, an automated verification and validation of the code migrated to the one or more directories may be performed.

In some aspects, the computing device may comprise a primary edge node, and the one or more other computing devices may comprise a plurality of secondary edge nodes. The method may further comprise after migrating the code to the one or more directories, synchronizing the code and the one or more directories to a plurality of user acceptance testing nodes. Tests may be performed on the plurality of user acceptance testing nodes. After performing the tests, the synchronizing the code and the one or more directories to the plurality of secondary edge nodes steps may be performed.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates another example operating environment in which various aspects of the disclosure may be implemented.

FIG. 3 illustrates an example operating environment and method for code migration in which various aspects of the disclosure may be implemented.

FIG. 4 illustrates an example display screen for signing on to a code migration environment in which various aspects of the disclosure may be implemented.

FIG. 5 illustrates an example display screen for requesting and reviewing code migration in which various aspects of the disclosure may be implemented.

FIGS. 6A-B illustrate an example display screen for entering application information for code migration in which various aspects of the disclosure may be implemented.

FIG. 7 illustrates an example display screen for displaying code migration requests in which various aspects of the disclosure may be implemented.

FIG. 8 illustrates another example display screen for displaying code migration requests in which various aspects of the disclosure may be implemented.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

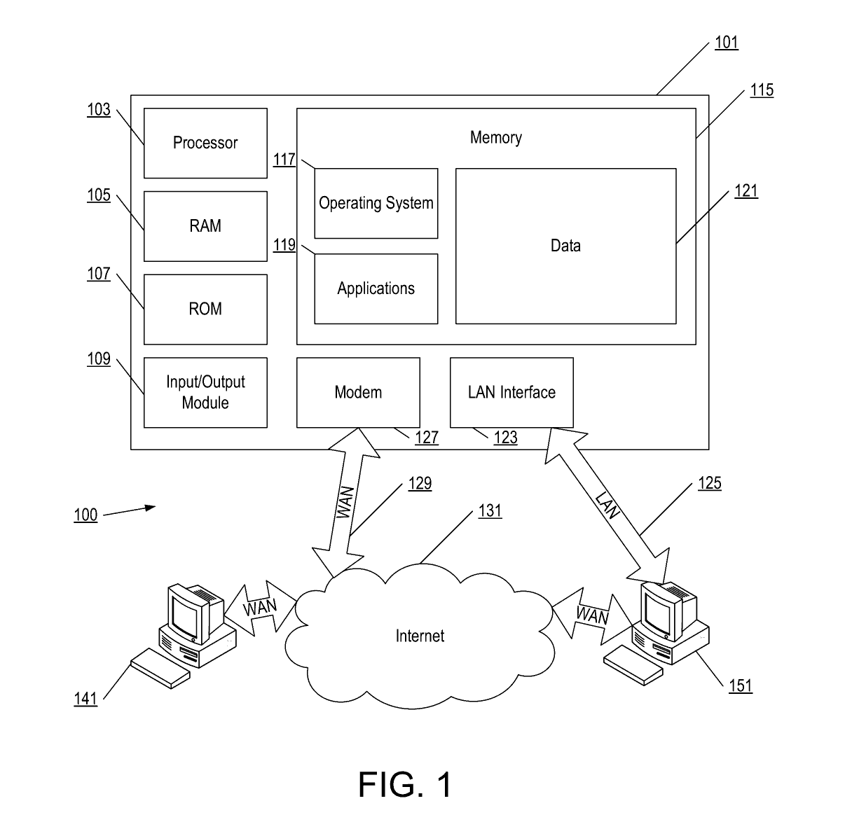

FIG. 1 illustrates an example block diagram of a computing device 101 (e.g., a computer server, desktop computer, laptop computer, tablet computer, other mobile devices, and the like) in an example computing environment 100 that may be used according to one or more illustrative embodiments of the disclosure. The computing device 101 may have a processor 103 for controlling overall operation of the server and its associated components, including for example random access memory (RAM) 105, read-only memory (ROM) 107, input/output (I/O) module 109, and memory 115.

I/O module 109 may include, e.g., a microphone, mouse, keypad, touch screen, scanner, optical reader, and/or stylus (or other input device(s)) through which a user of computing device 101 may provide input, and may also include one or more of a speaker for providing audio output and a video display device for providing textual, audiovisual, and/or graphical output. Software may be stored within memory 115 and/or other storage to provide instructions to processor 103 for enabling computing device 101 to perform various functions. For example, memory 115 may store software used by the computing device 101, such as an operating system 117, application programs 119, and an associated database 121. Additionally or alternatively, some or all of the computer executable instructions for computing device 101 may be embodied in hardware or firmware (not shown).

The computing device 101 may operate in a networked environment supporting connections to one or more remote computers, such as terminals 141 and 151. The terminals 141 and 151 may be personal computers or servers that include any or all of the elements described above with respect to the computing device 101. The network connections depicted in FIG. 1 include a local area network (LAN) 125 and a wide area network (WAN) 129, but may also include other networks. When used in a LAN networking environment, the computing device 101 may be connected to the LAN 125 through a network interface or adapter 123. When used in a WAN networking environment, the computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device 101 and/or terminals 141 or 151 may also be mobile terminals (e.g., mobile phones, smartphones, PDAs, notebooks, tablets, and the like) including various other components, such as a battery, speaker, and antennas (not shown).

The disclosure is operational with numerous types of general purpose or special purpose computing devices. Examples of well-known computing devices that may be suitable for use with the disclosure (including the system of FIG. 1) include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

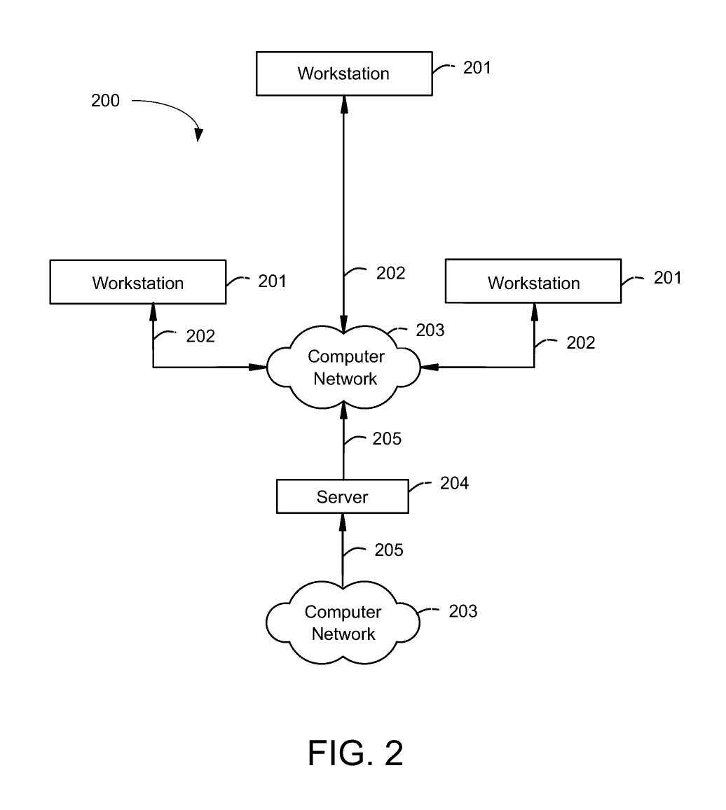

FIG. 2 illustrates another example operating environment in which various aspects of the disclosure may be implemented. An illustrative system 200 for implementing methods according to the present disclosure is shown. As illustrated, system 200 may include one or more workstations 201. The workstations 201 may be used by, for example, agents or other employees of an institution (e.g., a financial institution) and/or customers of the institution. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, and the like.

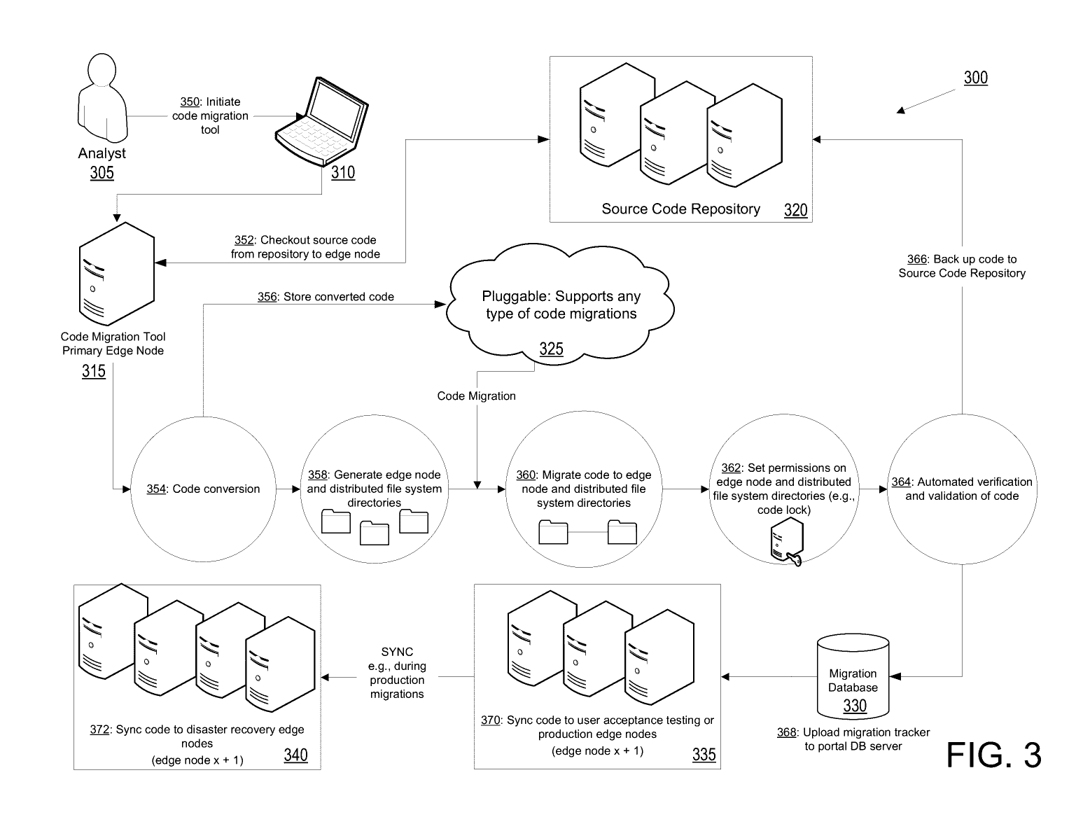

FIG. 3 illustrates an example operating environment and method 300 for code migration in which various aspects of the disclosure may be implemented. The operating environment 300 may include a plurality of devices, such as user devices, code repositories, and edge nodes, communicating with one another and processing data to increase the speed and quality of code migrations in a network of computing devices. One or more analysts 305 may manage code migration within a network of computing devices. The analyst 305 may comprise, for example, an administrator, such as an enterprise environment management administrator. The code migration may be performed via a distributed file system, such as Apache Hadoop. Code may be migrated (e.g., deployed) in user acceptance testing and production phases, as will be described in further detail below. Duties between the development phase, the testing phase, and the production phase may be separated among one or more users.

In step 350, the analyst 305 may initiate a code migration tool using a computing device 310, such as the analyst's laptop computer, workstation, mobile device, and the like. As will be described in further detail below, the analyst 305 may select an option to request code migration to initiate the tool. Code migration may also be automated (e.g., without input from an analyst). The code migration tool may also be initiated based on the analyst 305 signing on to a code migration environment.

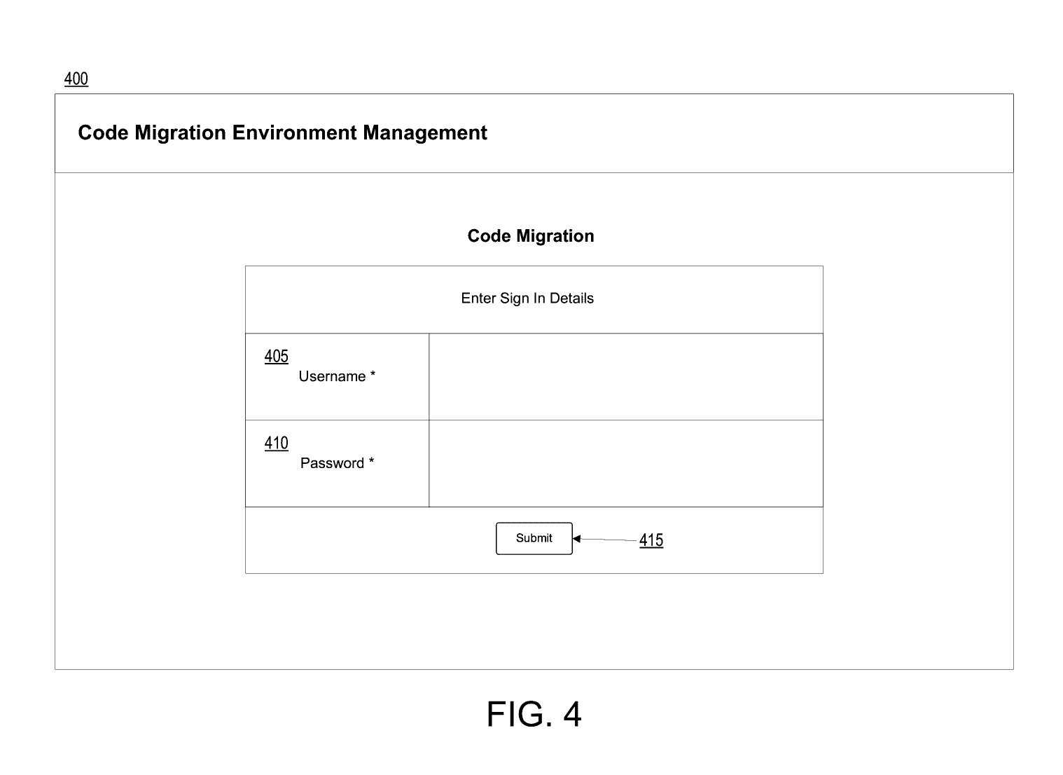

FIG. 4 illustrates an example display screen 400 for signing on to a code migration environment in which various aspects of the disclosure may be implemented. The display screen 400 may be displayed on, for example, a display of the analyst's device 310. The display screen 400 may display one or more data input fields for the analyst 305 to sign on (e.g., provide credentials) to the code migration environment, such as a username field 405 and a password field 410. Alternative credentials include, but are not limited to, a personal identification number (PIN), a one-time password (OTP), biometrics, and the like. The analyst may select the submit option 415 for the device 310 to send the analyst's credentials for authentication. Once authenticated, the analyst may be granted access to the code migration environment.

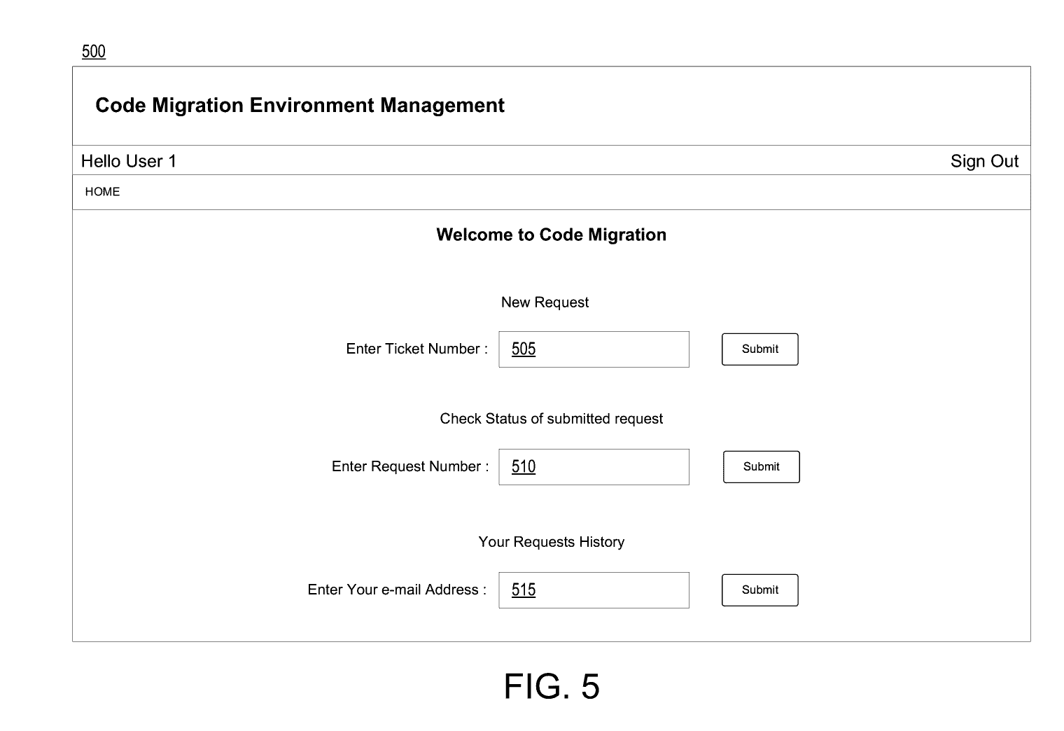

FIG. 5 illustrates an example display screen 500 for requesting and reviewing code migration in which various aspects of the disclosure may be implemented. The display screen 500 may be displayed on, for example, a display of the analyst's device 310. In some aspects, the display screen 500 may be displayed after (e.g., in response to) the analyst authenticates using his or her credentials. The display screen 500 may include a data input field 505 for requesting a new migration, a data input field 510 for checking the status of a previously submitted request, and/or a data input field 515 for viewing the analyst's (or another analyst's) history of code migration requests. Each code migration request may be assigned a unique identifier, such as a ticket number, a request number, and the like, that identifies the request. The analyst 305 may input, such as into data field 505 or 510, the unique identifier to request a new migration or check the status of a previous request. The analyst 305 may also input, such as into data field 515, an identifier unique to the analyst, and the device 310 may display the analyst's history of code migration requests in response.

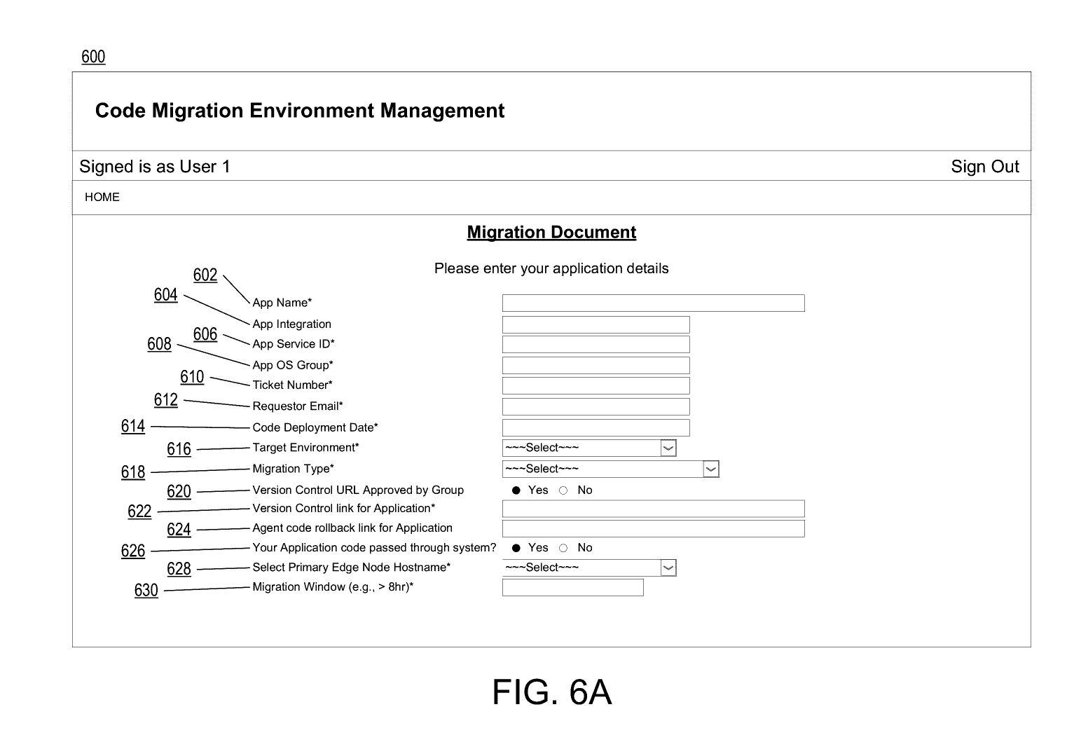

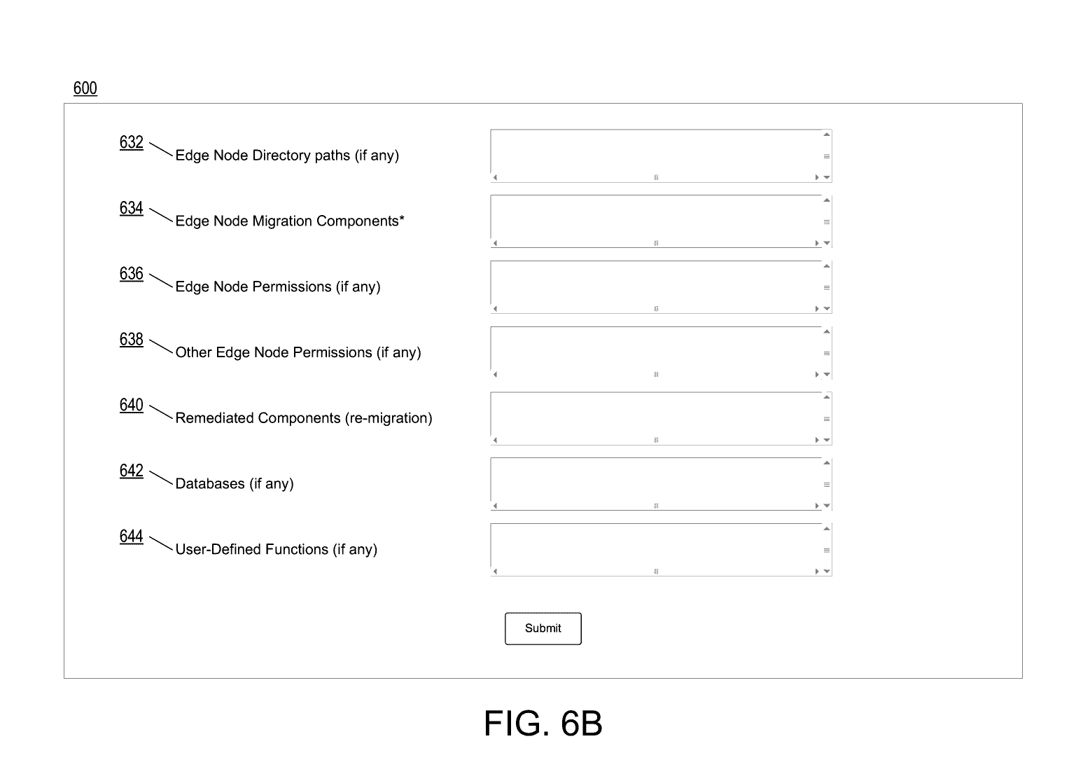

FIGS. 6A-B illustrate an example display screen 600 for entering application information for code migration in which various aspects of the disclosure may be implemented. The display screen 600 may be displayed on, for example, a display of the analyst's device 310. In some aspects, the display screen 600 may be displayed after (e.g., in response to) the analyst 305 selects the option 505 to create a new request, as illustrated in FIG. 5. The display screen 600 may display a plurality of data input fields for the analyst 305 to provide information for the new code migration.

In data field 602, the analyst 305 may provide a name for the application (or other code) being migrated. In data field 604, the analyst 305 may provide an identification code that identifies the application (or other code) within an application integration framework that owns or executes the code being migrated. Exemplary identification codes include ABC and 123. In data field 606, the analyst 305 may provide a service ID for the application. The service ID may comprise the user ID that executes the code in the target environment (e.g., user acceptance testing or production). The service ID may be used to set ownership to the application's directories and files. In data field 608, the analyst 305 may provide an operating system (OS) group identifier for the application, such as a UNIX or WINDOWS group. Each OS group may contain a list of users that have access to the directories and files based on OS permission settings for the directories and files. In data field 610, the analyst 305 may provide a ticket number for the request. The ticket number field 610 may be prepopulated if the analyst 305 previously entered the ticket number in the display screen 500 illustrated in FIG. 5. In data field 612, the analyst 305 may provide an email of the user making the code migration request, such as the analyst 305's own email address. The analyst 305 may similarly provide any other unique identifier, such as an employee ID, a social security number, and the like. In data field 614, the analyst 305 may provide a deployment date for the code migration.

In data field 616, the analyst 305 may provide the target environment for the code migration. The data field 616 may include a drop-down menu for the analyst 305 to select the target environment. Using the drop-down menu, the user may select from a list of pre-defined platforms the code is to be migrated to, such as User Acceptance Platform, Production A Platform, Production B Platform, and the like. The menu may be a configurable setting, and platform names may be added to and removed from the drop-down list. In data field 618, the analyst 305 may provide a migration type. The data field 618 may include a drop-down menu for the analyst 305 to select the migration type. Exemplary migration types include a project first migration, a project re-migration, and an emergency migration. The first migration option may be selected when the full code set for a particular project is to be migrated to a target platform. The re-migration option may be selected for code that is to be re-migrated to the target after its first migration. The emergency migration option may be selected for moving code to a production environment in the event of a code break or fix situation. The drop-down menu may be configurable, and migration types may be added to or removed from the drop-down menu.

In data field 620, the analyst 305 may select whether the version control URL for the application has been approved by a particular group, such as a data security group. In data field 622, the analyst 305 may provide the version control link (e.g., URL) for the application, e.g., if the analyst selected yes in data field 620. Once code has been migrated to a target environment, a backup may be created in the source repository with a version number. The version control link may be used to access a specific version of code that has been migrated to the target environment in the event the newly migrated code is to be backed out and a previous version of the code restored. This option may generally be used for migrations to a production environment. In data field 624, the analyst 305 may provide a code rollback link (e.g., URL) for the application. A rollback may be useful if the new version for the application has, for example, bugs or is incompatible with the system or servers therein. In data field 626, the analyst 305 may select whether the application code passed through a job scheduling tool. The scheduling tool or application may be used to schedule jobs to be performed by the code migration system 300. In data field 628, the analyst 305 may select a hostname (or other identifier) for the primary edge node that will manage the code migration. The data field 628 may include a drop down menu for selecting the hostname. The primary edge node will be described in further detail in the examples that follow. In data field 630, the analyst 305 may provide a time window for the code migration. In some aspects, the code migration environment may request that the time window exceeds a predetermined length of time, such as 8 hours. The migration window may comprise a specific time range that the code can be migrated to a target location. The window may be used to prevent code from being migrated during a time the application is executing on the target environment.

Attention is turned to FIG. 6B, which may comprise a continuation of the display screen 600 illustrated in FIG. 6A. In data field 632, the analyst 305 may provide one or more edge node directory paths (if any). The edge node directories may contain the executable code and data files going in and out of the distributed files system. In data field 634, the analyst 305 may provide one or more edge node migration components. This field may indicate the code to be migrated to specific directories on the edge node. In data field 636, the analyst 305 may provide one or more edge node permissions (if any). This field may set the OS (e.g., UNIX) permissions, such as UNIX 750 permissions, for edge node directories. Exemplary permissions may indicate that the owning ID has read, write, execute permissions and the OS group has read and execute permissions. In data field 638, the analyst 305 may provide one or more other edge node permissions (if any). This field may set the OS permissions, such as UNIX 770 permissions, for edge node directories. Exemplary permissions may indicate that both the owning ID and the OS group have read, write, and execute permissions. In data field 640, the analyst 305 may provide one or more remediated components (e.g., for re-migration). This field may list the directories and components for re-migration. In data field 642, the analyst 305 may provide one or more databases (if any). This field may comprise an informational block and can be configured based on need or may be removed. In data field 644, the analyst 305 may provide one or more user-defined functions (if any). This field may list user-defined functions or other specialized code that is to be installed at the OS server level. Items 632-644 described above may be customizable based on the installation needs and policies regarding directory locations, permission settings, and code component storage.

Returning to FIG. 3, the computing device 310 may communicate with an edge node 315, such as a primary edge node, which may be used to manage code migration. The edge node 315 may comprise a computing device, such as a server (e.g., a mid-range server), as described herein. The edge node 315 may be utilized as a gateway to a distributed file system, such as a Hadoop Distributed File System (HDFS) and may include a code migration tool. Accordingly, requests from users to the distributed file system may pass through the edge node 315.

In step 352, the edge node 315 may send a request to a source code repository 320 for the code (e.g., one or more scripts) to be migrated. In some aspects, code developers may deposit code to be migrated in the future into the source code repository 320, which may comprise, for example a server having a database or flat file system. The code may be programmed using any programming language, including, for example, apache, shell script, java, python, c, c++, and the like. The edge node 315 may load (e.g., checkout) the relevant source code from the repository 320. The relevant source code may be identified based on the information provided by the analyst 305 via display screen 500 and/or display screen 600, as previously described. The edge node 315 may temporarily store (e.g., cache) the checked-out source code.

In step 354, the edge node 315 may convert the code checked out from the repository 320 from one format to another format. For example, assume that the source code in the repository is in disk operating system (DOS) format, but the desired format is UNIX. The edge node 315 may convert the code in DOS format to UNIX format using dos2unix. Other exemplary conversions include, but are not limited to, unix2dos conversion, a tr conversion (e.g., to remove extra carriage returns), an awk conversion, and the like. Conversions may remove certain characters in the code incompatible with the desired format (e.g., UNIX) or add certain characters in the code to make the code compatible with the desired format. If the code is already in the desired format, the edge node 315 might not perform a code conversion.

In step 356, the edge node 315 may store the code converted in step 354 in a holding repository 325. The holding repository 325 may comprise, for example, physical memory within the edge node 315. The holding repository 325 may be pluggable and support any type of code migration.

In step 358, the edge node 315 may generate (e.g., create) one or more edge node (e.g., gateway server) directories. The edge node 315 may additionally or alternatively create one or more distributed file system directories, such as Hadoop Distributed File System (HDFS) directories. The created directories may be stored in the edge node 315. The directories may comprise, for example, the directories and code components provided by the user in fields 632-644 previously described with reference to FIG. 6B. For the distributed file system, a base directory structure may be created for the application to process and store its data.

In step 360, the edge node 315 may migrate the code stored in the holding repository into the edge node directories and/or the distributed file system directories after the directories are created and set up. The code in the distributed file system directories may comprise a safe copy, in case one or more edge nodes fails in the future. The code may be copied from the distributed file system to an edge node in the event of a failure.

In step 362, the edge node 315 may set permissions on the edge node directories and/or distributed file system directories. For example, the code may be locked. Users (e.g., code developers) may be granted permission to read the code in a particular directory, but not to write (e.g., cannot edit the code). Users may alternatively be granted permission to read and to write. Another permission that may be toggled may comprise the ability to execute (e.g., run) the scripts in the code. Permissions may be set on a directory-by-directory basis, and the directories may have the same permissions or may each have different permissions.

In step 364, the edge node 315 may perform an automated verification and/or validation of the code in the directories. The edge node 315 may verify that all of the code intended to be migrated (e.g., as indicated by developers) has been copied to each of the directories. The edge node 315 may also confirm that permissions have been set for each directory, and that the permissions are correct. Automated verification and/or validation may be a customizable feature that utilizes coded rules based on the installation's standards and policies. It may also perform specific checks to determine if the tool performed the migration tasks as expected. Rules may be added or removed based on past experience from information submitted by developers. For example, verification and/or validation may be used to determine whether directories have been created on all registered edge nodes as requested, whether the code was migrated to all registered edge nodes as requested, whether the directory paths include any special characters, whether the directory paths include any spaces, whether all the requested code components to be migrated were copied to the source repository, and the like.

In step 366, the edge node 315 may back up the code, which may be converted, organized, protected, verified, and/or validated for migration, to the source code repository 320. In some examples, the backup may comprise the entire set of code migrated to the directories in step 360. By backing up the code, the system 300 may be able to revert to a previous version of the code if a failure of the current version occurs.

In step 368, the edge node 315 may send the code to a migration database 330, such as a portal database server (e.g., a web portal database server, a database management system (DBMS), and the like). For example, a migration tracker may be uploaded to the migration database 330. The migration database comprising the uploaded code may be pluggable with any other database, such as a Structured Query Language (SQL) database. Information on the migration may be collected and reports may be generated in step 368. Example migration information includes, but is not limited to, who performed the migration, when the migration occurred, the version of the application software migrated, and the like.

In step 370, the code may be synchronized to other edge nodes, such as user acceptance testing (UAT) or production edge nodes 335. The nodes 335 may comprise one or more computing devices, similar to the primary edge node 315, as previously described. While three such nodes 335 are illustrated, the code may be synchronized to any number of UAT and/or production edge nodes 335 (e.g., four edge nodes, six edge nodes, seven edge nodes, or any number of edge nodes). The primary edge node 315 and the UAT and/or production edge nodes 335 may comprise a server cluster. The edge node 315 and/or the migration database 330 may perform the synchronization. Synchronization may comprise copying the code to the nodes 335. Synchronization may also comprise copying the directories created in step 358 and the permissions set in step 362 to the nodes 335. By synchronizing the code, the code may be run from other edge nodes 335 if the primary edge node 315 has a failure, such as a hardware failure.

In some examples, the code may first be synchronized to one or more UAT nodes. Users of the system (which may be the developers or not) may perform code verification (e.g., testing) of the code in the UAT nodes. Once the code has been verified, the edge node 315 or the migration database 330 may be initiated to synchronize the code to one or more production edge nodes for rollout.

In step 372, the code may be synchronized (e.g., copied) to one or more disaster recovery edge nodes 340 for disaster recovery. The nodes 340 may comprise one or more computing devices, similar to the primary edge node 315, as previously described. Moreover, the servers 340 may comprise a server cluster. While four such disaster recovery nodes 340 are illustrated, the code may be synchronized to any number of disaster recovery edge nodes 340. The edge node 315, the migration database 330, and/or the UAT or other nodes 335 may perform the synchronization. In some aspects, the synchronization to the disaster recovery edge nodes 340 may occur during production migrations, but not UAT migrations. The disaster recovery nodes 340 may be mirrored with the primary edge node 315 and production edge nodes 335.

Any of the devices, components, and/or steps previously described, such as the source code repository 320, code conversion 354, directory creation 358, code migration 360, code permissions 362, code verification and/or validation 364, migration database 330, and/or code synchronization 335 and/or 340, may be pluggable. Pluggable components may be used in various other systems. For example, the pluggable code repository 320 may be plugged in to a different code migration system. Similarly, other pluggable code repositories may be plugged in to the system 300 to be used for code migration. The same may be performed for other pluggable devices, components, and/or steps.

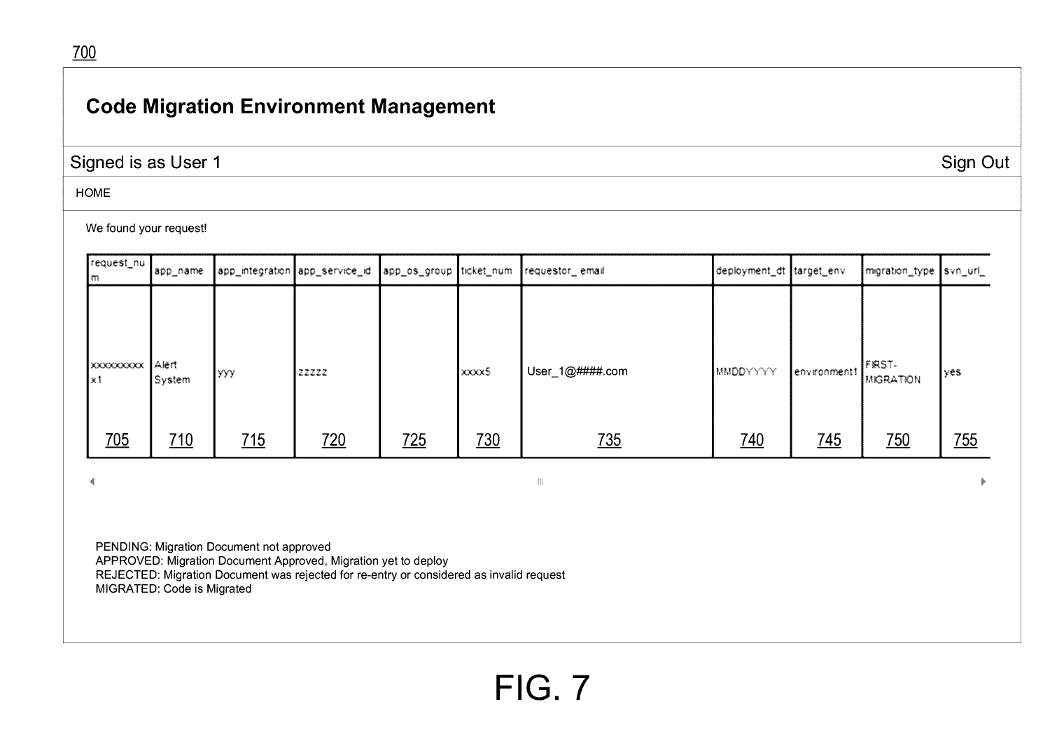

FIG. 7 illustrates an example display screen 700 for displaying code migration requests in which various aspects of the disclosure may be implemented. The display screen 700 may be displayed on, for example, a display of the analyst's device 310. In some aspects, the display screen 700 may be displayed after (e.g., in response to) the analyst 305 selecting the option 510 to check the status of a request, as illustrated in FIG. 5. The display screen 700 may display a plurality of data fields indicating the status of a code migration.

The display screen 700 may indicate the request number 705, which may have been provided by the analyst 305 in the input data field 510. The display screen 700 may indicate the application name 710, such as “Alert System.” The display screen 700 may indicate 715 the application (or other code) within an application integration framework. The display screen 700 may indicate the service ID 720 for the application. The display screen 700 may indicate the OS group identifier 725 for the application. The display screen 700 may indicate the ticket number 730 for the code migration request. The display screen 700 may indicate the analyst's identifier 735, such as email address. The display screen 700 may indicate the deployment date 740 for the code migration. The display screen 700 may indicate the target environment 745 for the migration. The display screen 700 may indicate the migration type 750, such as if the code migration is the first migration. The display screen 700 may indicate the version control URL 755 for the code or application.

In general, the display screen 700 may display any of the data fields input by the analyst, as described above in reference to FIGS. 6A-B. Additionally, the display screen 700 may indicate whether the migration is pending (e.g., the migration document is not yet approved), approved (e.g., the migration document was approved, but the migration has yet to deploy), rejected (e.g., the migration document was rejected for re-entry or considered as an invalid request), or migrated (e.g., the code is migrated).

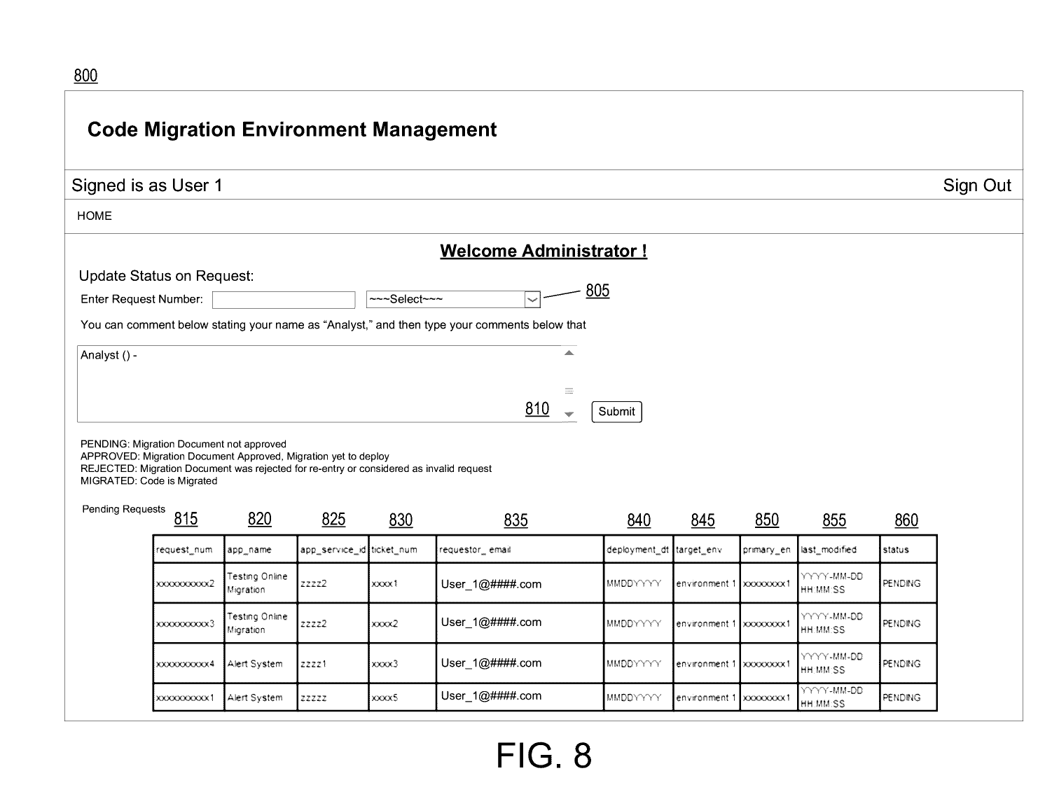

FIG. 8 illustrates another example display screen 800 for displaying code migration requests in which various aspects of the disclosure may be implemented. The display screen 800 may be displayed on, for example, a display of the analyst's device 310. In some aspects, the display screen 800 may be displayed after (e.g., in response to) the analyst 305 selects the option 515 to view the analyst's request history, as illustrated in FIG. 5.

The display screen 800 may list one or more pending, approved, rejected, and/or migrated requests for the analyst 305. The exemplary display screen 800 displays four pending requests for the analyst 305. The display screen 800 may indicate the request number 815 for each request. The display screen 800 may indicate the application name 820 for each request. The display screen 800 may indicate the application service ID 825 for each request. The display screen 800 may indicate the ticket number 830 for each code migration request. The display screen 800 may indicate the analyst's identifier 835, such as email address, for each request. The display screen 800 may indicate the deployment date 840 for each code migration. The display screen 800 may indicate the target environment 845 for each migration. The display screen 800 may indicate the primary edge node 850 (e.g., via its hostname or other identifier) for each request. The display screen 800 may indicate when each request was last modified 855. The display screen 800 may also indicate the status of each request for the user, such as pending, approved, rejected, or migrated.

The display screen 800 may also allow a user (e.g., an analyst or administrator) to update the status for one or more requests. For example, the user may enter a request number and select 805 whether the status should be changed to pending, approved, rejected, or migrated. The display screen 800 may also allow the user to provide a comment on the request, such as a reason for changing the request status, in the comment input field 810.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method comprising:
sending, by a computing device and to a code repository, a request to migrate code, the request comprising an identifier for the code;
in response to the request to migrate, receiving, at the computing device and from the code repository, the code;
generating, by the computing device, one or more directories for the code;
migrating, by the computing device, the code to the one or more directories; and
synchronizing the code and the one or more directories to one or more other computing devices.

2. The method of claim 1, further comprising:
generating, for display on a user device, a display screen for a code migration tool of the computing device; and
in response to receiving, from the display screen, the identifier for the code, performing the sending the request to migrate the code.

3. The method of claim 1, further comprising:
prior to migrating the code to the one or more directories, converting the code from a first format to a second format,
wherein migrating the code to the one or more directories comprises migrating the code converted from the first format to the second format to the one or more directories.

4. The method of claim 1, wherein the one or more directories comprise a plurality of edge node directories and a plurality of distributed file system directories, and wherein migrating the code to the one or more directories comprises copying the code to the plurality of edge node directories and the plurality of distributed file system directories.

5. The method of claim 1, further comprising:
after migrating the code to the one or more directories, setting at least one of a read permission, a write permission, or an execute permission for the code.

6. The method of claim 1, further comprising:
after migrating the code to the one or more directories, performing an automated verification and validation of the code migrated to the one or more directories.

7. The method of claim 1, wherein the computing device comprises a primary edge node, and the one or more other computing devices comprise a plurality of secondary edge nodes, the method further comprising:
after migrating the code to the one or more directories, synchronizing the code and the one or more directories to a plurality of user acceptance testing nodes;
performing tests on the plurality of user acceptance testing nodes; and
after performing the tests, performing the synchronizing the code and the one or more directories to the plurality of secondary edge nodes.

8. An apparatus, comprising:
a processor; and
memory storing computer-executable instructions that, when executed by the processor, cause the apparatus to:
send, to a code repository, a request to migrate code, the request comprising an identifier for the code;
in response to the request to migrate, receive, from the code repository, the code;
generate one or more directories for the code;
migrate the code to the one or more directories; and
synchronize the code and the one or more directories to one or more other computing devices.

9. The apparatus of claim 8, wherein the memory stores additional computer-executable instructions that, when executed by the processor, cause the apparatus to:
generate, for display on a user device, a display screen for a code migration tool of the computing device; and
in response to receiving, from the display screen, the identifier for the code, perform the sending the request to migrate the code.

10. The apparatus of claim 8, wherein the memory stores additional computer-executable instructions that, when executed by the processor, cause the apparatus to:
prior to migrating the code to the one or more directories, convert the code from a first format to a second format,
wherein migrating the code to the one or more directories comprises migrating the code converted from the first format to the second format to the one or more directories.

11. The apparatus of claim 8, wherein the one or more directories comprises a plurality of edge node directories and a plurality of distributed file system directories, and wherein migrating the code to the one or more directories comprises copying the code to the plurality of edge node directories and the plurality of distributed file system directories.

12. The apparatus of claim 8, wherein the memory stores additional computer-executable instructions that, when executed by the processor, cause the apparatus to:
after migrating the code to the one or more directories, set at least one of a read permission, a write permission, and an execute permission for the code.

13. The apparatus of claim 8, wherein the memory stores additional computer-executable instructions that, when executed by the processor, cause the apparatus to:
after migrating the code to the one or more directories, perform an automated verification and validation of the code migrated to the one or more directories.

14. The apparatus of claim 8, wherein the computing device comprises a primary edge node, and the one or more other computing devices comprises a plurality of secondary edge nodes, and wherein the memory stores additional computer-executable instructions that, when executed by the processor, cause the apparatus to:
after migrating the code to the one or more directories, synchronize the code and the one or more directories to a plurality of user acceptance testing nodes;
perform tests on the plurality of user acceptance testing nodes; and
after performing the tests, perform the synchronizing the code and the one or more directories to the plurality of secondary edge nodes.

15. One or more non-transitory computer-readable medium having instructions stored thereon that, when executed by one or more computing devices, cause the one or more computing devices to:
send, to a code repository, a request to migrate code, the request comprising an identifier for the code;
in response to the request to migrate, receive, from the code repository, the code;
generate one or more directories for the code;
migrate the code to the one or more directories; and
synchronize the code and the one or more directories to one or more other computing devices.

16. The one or more non-transitory computer-readable medium of claim 15, having computer-readable instructions stored thereon that, when executed by the one or more computing devices, cause the one or more computing devices to:
generate, for display on a user device, a display screen for a code migration tool of the computing device; and
in response to receiving, from the display screen, the identifier for the code, perform the sending the request to migrate the code.

17. The one or more non-transitory computer-readable medium of claim 15, having computer-readable instructions stored thereon that, when executed by the one or more computing devices, cause the one or more computing devices to:
prior to migrating the code to the one or more directories, convert the code from a first format to a second format,
wherein migrating the code to the one or more directories comprises migrating the code converted from the first format to the second format to the one or more directories.

18. The one or more non-transitory computer-readable medium of claim 15, wherein the one or more directories comprises a plurality of edge node directories and a plurality of distributed file system directories, and wherein migrating the code to the one or more directories comprises copying the code to the plurality of edge node directories and the plurality of distributed file system directories.

19. The one or more non-transitory computer-readable medium of claim 15, having computer-readable instructions stored thereon that, when executed by the one or more computing devices, cause the one or more computing devices to:
after migrating the code to the one or more directories, set at least one of a read permission, a write permission, and an execute permission for the code.

20. The one or more non-transitory computer-readable medium of claim 15, having computer-readable instructions stored thereon that, when executed by the one or more computing devices, cause the one or more computing devices to:
after migrating the code to the one or more directories, perform an automated verification and validation of the code migrated to the one or more directories.
